(19) United States
(12) Patent Application Publication
(10) Pub. No.: US 2026/0169408 A1
(43) Pub. Date: Jun. 18, 2026

(54) FIXING UNIT

(71) Applicant: CANON KABUSHIKI KAISHA, Tokyo (JP)

(72) Inventors: KENICHIROU ISOBE, Kanagawa (JP); TAKAFUMI SUZUKI, Shizuoka (JP)

(21) Appl. No.: 19/413,566

(22) Filed: Dec. 9, 2025

(30) Foreign Application Priority Data
Dec. 18, 2024 (JP) 2024-223114

(51) Int. Cl. G03G 15/20

(52) U.S. Cl. CPC G03G 15/2053; G03G 15/2064; G03G 2215/2035

(57) ABSTRACT

A fixing unit includes a rotary member, an opposing member, a magnetic core, a conductive coil, and a metallic side plate. The side plate is disposed at a position deviated in an axial direction with respect to a sheet passing area where a recording material passes by being nipped and conveyed in a conveyance direction by the rotary member and the opposing member. The side plate includes an inner surface facing the rotary member, and an outer surface. When a region where a region between a first end and a second end of a helical portion and a region where a magnetic core is present overlap in an axial direction is referred to as an overlap region, the overlap region includes a region that projects beyond the inner surface in a first direction that is a direction from the inner surface toward the outer surface.

### BACKGROUND

### Field of the Technology

This disclosure relates to a fixing unit that fixes a toner image on a recording material.

### Description of the Related Art

Fixing units are typically mounted to copiers and printers of electrophotographic systems and fixing units using electromagnetic induction heating methods are known. Japanese Patent Laid-Open Publication No. 2015-118256, describes a fixing unit that includes a fixing film having a conductive layer, a magnetic core disposed in an internal space of the fixing film, and a helical conductive coil wound around the magnetic core. In this fixing unit, when an alternating current flows through the conductive coil to generate an alternating magnetic field, a circulating current flows through a heat generation layer of the fixing film due to the principle of electromagnetic induction. In addition, this fixing unit improves the heat generation efficiency of a rotary member by increasing the magnetic flux that contributes to heat generation.

However, in the fixing unit described in Japanese Patent Laid-Open Publication No. 2015-118256, the magnetic core is supported, for example, by metallic members such as a side plate and a stay, and there is a possibility that the alternating magnetic field generated by energizing the conductive coil may pass through the metallic members and generate eddy currents. Due to the eddy current generation, there is a risk that the metallic members may generate heat and consume unnecessary electrical power, and the reduced heat generation efficiency of the fixing film may result.

### SUMMARY

This disclosure aims to provide a fixing unit that can improve the heat generation efficiency of a fixing film.

According to a first aspect of the present disclosure, a fixing unit configured to fix a toner image on a recording material includes a rotary member configured to rotate and formed in a tubular shape, an opposing member configured to form a nip portion with the rotary member by coming into contact with an outer circumferential surface of the rotary member and configured to rotate around a rotational axis as a center, the rotational axis extending in an axial direction, a magnetic core disposed in an internal space of the rotary member, a conductive coil disposed in the internal space of the rotary member and including a helical portion helically wound around the magnetic core, the helical portion including a first end in the axial direction and a second end on a side opposite to the first end, and a metallic side plate disposed at a position deviated in the axial direction with respect to a sheet passing area where the recording material passes by being nipped and conveyed in a conveyance direction by the rotary member and the opposing member. The side plate includes an inner surface facing the rotary member, and an outer surface that is an opposite surface of the inner surface. In a case where a region where a region between the first end and the second end of the helical portion and a region where the magnetic core is present overlap in the axial direction is referred to as an overlap region, the overlap region includes a region that projects beyond the inner surface in a first direction that is a direction from the inner surface toward the outer surface.

According to a second aspect of the present disclosure, a fixing unit configured to fix a toner image on a recording material includes a rotary member configured to rotate and formed in a tubular shape, an opposing member configured to form a nip portion with the rotary member by coming into contact with an outer circumferential surface of the rotary member and configured to rotate around a rotational axis as a center, the rotational axis extending in an axial direction, a magnetic core disposed in an internal space of the rotary member, a conductive coil disposed in the internal space of the rotary member and including a helical portion helically wound around the magnetic core, the helical portion including a first end in the axial direction and a second end on a side opposite to the first end, and a metallic metal member disposed in the internal space of the rotary member. The metal member includes a downstream end in a first direction that is a direction from the first end toward the second end in the axial direction. In a case where a region where a region between the first end and the second end of the helical portion and a region where the magnetic core is present overlap in the axial direction is referred to as an overlap region, the overlap region includes a region that overlaps at least the downstream end.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an image forming apparatus according to a first embodiment.

FIG. 2 is a schematic perspective view illustrating a fixing unit according to the first embodiment.

FIG. 3 is an exploded perspective view illustrating the fixing unit according to the first embodiment.

FIG. 4 is a perspective view illustrating a state taken along the line A-A of FIG. 2.

FIG. 5 is a schematic diagram illustrating a heat generation mechanism of the fixing unit according to the first embodiment.

FIG. 6 is a schematic diagram illustrating magnetic flux lines generated in a case where a helical portion of a conductive coil is shorter than a magnetic core.

FIG. 7 is a schematic diagram illustrating magnetic flux lines generated in a case where the helical portion of the conductive coil is longer than the magnetic core.

FIG. 8 is a schematic diagram illustrating magnetic flux lines leaking from an overlap region of the magnetic core and the conductive coil.

FIG. 9 is a schematic diagram illustrating a state in which the magnetic flux lines pass through a metallic plate.

FIG. 10 is a plan view illustrating the overlap region of the magnetic core and the conductive coil according to the first embodiment.

FIG. 11 is a perspective view illustrating the magnetic core, the conductive coil, and a stay according to the first embodiment.

FIG. 12 is a schematic diagram illustrating the flow of the magnetic flux lines in the magnetic core and the conductive coil according to the first embodiment.

FIG. 13 is a schematic diagram illustrating the flow of magnetic flux lines in the magnetic core and the conductive coil according to a first comparative example.

FIG. 14 is a schematic diagram illustrating the flow of magnetic flux lines in the magnetic core and the conductive coil according to a second comparative example.

FIG. 15 is an exploded perspective view illustrating a fixing unit according to a second embodiment.

FIG. 16 is a perspective view illustrating the fixing unit according to the second embodiment.

FIG. 17 is a schematic diagram illustrating the flow of magnetic flux lines according to the second embodiment.

FIG. 18 is a schematic diagram illustrating the flow of the magnetic flux lines in the magnetic core and the conductive coil according to the second embodiment.

### DESCRIPTION OF THE EMBODIMENTS

Hereinafter, with reference to drawings, embodiments according to this disclosure will be described. In this disclosure, the term “image forming apparatus” is not limited to single-function printers equipped only with a printing function, but broadly includes apparatuses that form images on recording materials, such as copiers with copying functions, multifunction machines with multiple functions, and large-format commercial printers. In addition, in this disclosure, the term “fixing unit” broadly includes apparatuses (image heating apparatuses) that heat the images formed on the recording materials by electrophotographic processes or the like to fix the images on the recording materials. The fixing unit may also be configured to apply additional heat to an image that has already undergone fixing (primary fixing) on the recording material, so as to provide gloss.

### First Embodiment

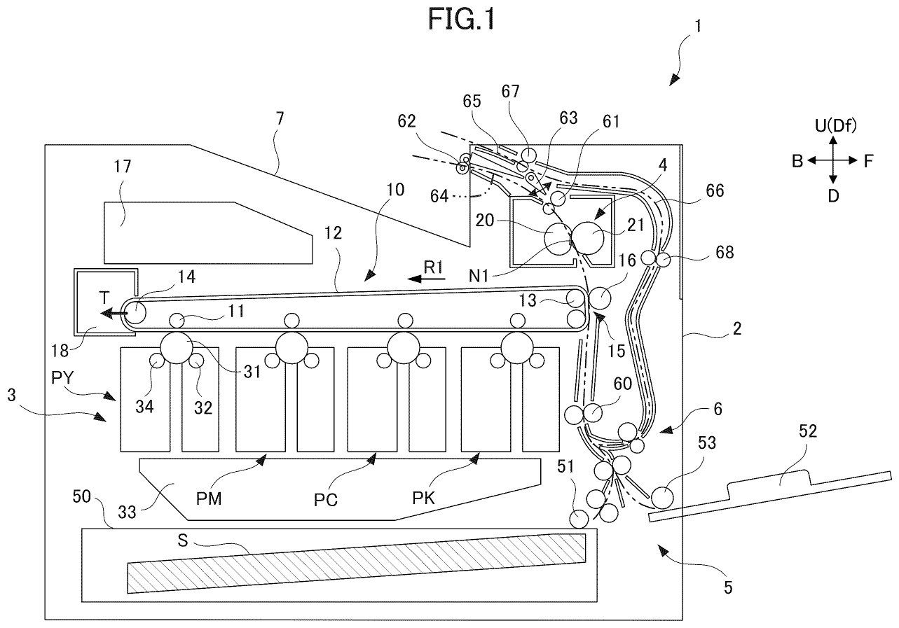

A configuration of a fixing unit 4 according to this disclosure will be described with reference to FIGS. 1 to 12. Here, an overall configuration of an image forming apparatus 1 employing the fixing unit 4 will be described, and, subsequently, the configuration of the fixing unit 4 according to this disclosure will be described. In this embodiment, a direction in which a manual feed tray 52, described below, opens with respect to an apparatus body 2 is referred to as a front side, that is a forward direction F. An opposite side is referred to as a backward direction B, a right side as viewed from the front side as a rightward direction R, a left side as viewed from the front side as a leftward direction L, an upper side as an upward direction U, and a lower side as a downward direction D. In addition, the upward direction U is also referred to as a sheet conveyance direction Df, the rightward direction R as a first direction D1, the leftward direction L as a second direction D2, and a left-right direction as a width direction W, which is perpendicular to the sheet conveyance direction Df. The second direction D2 is a direction opposite to the first direction D1.

### Image Forming Apparatus

With reference to FIG. 1, the overall configuration of the image forming apparatus according to a first embodiment of this disclosure will be described. FIG. 1 is a cross-sectional view illustrating a schematic configuration of the image forming apparatus 1. As illustrated in FIG. 1, the image forming apparatus 1 is a color laser beam printer that forms the image on a sheet S, serving as the recording material. The image forming apparatus 1 produces output by forming the image on the sheet S based on image information input from external devices such as a personal computer. As the sheet S, in addition to standard paper, the sheet S also includes specialty paper such as coated paper, recording materials with a special shape such as envelopes and index sheets, as well as plastic films for overhead projectors, cloth, and the like.

The apparatus body 2 of the image forming apparatus 1 includes an image forming section 3, which forms the image (toner image) on the sheet S through an electrophotographic process, the fixing unit 4, which fixes the toner image on the sheet S, a sheet feed unit 5, which feeds the sheet S to the image forming section 3, and a conveyance unit 6, which conveys the sheet S.

The image forming section 3 employs an intermediate transfer tandem system, and includes four image forming units PY, PM, PC, and PK, and an intermediate transfer unit 10. The image forming units PY, PM, PC, and PK respectively form the toner images of yellow, magenta, cyan, and black. Since configurations of the image forming units PY, PM, PC, and PK are the same except for the color of toner used for development, hereinafter, the configuration of the image forming unit and an image forming operation of the toner image will be described using the image forming unit PY for yellow as an example.

The image forming unit PY includes a photosensitive drum 31, serving as an image bearing member, a charge roller 32, serving as a charge unit, a laser scanner 33, serving as an exposing unit, and a developing unit 34, serving as a developing unit. In the image forming operation, when the formation of the toner image is requested with respect to the image forming unit PY, the photosensitive drum 31 is rotatably driven, and the charge roller 32 uniformly charges a surface of the photosensitive drum 31. The laser scanner 33 irradiates the photosensitive drum 31 with laser light based on the image information to expose the drum surface, and forms an electrostatic latent image on the photosensitive drum 31. The electrostatic latent image is visualized (developed) with the toner supplied from the developing unit 34, and, thereby, the toner image is formed on the surface of the photosensitive drum 31.

Similarly, also in the image forming units PM, PC, and PK, the toner images of corresponding colors are formed. The toner images formed by each of the image forming units PY, PM, PC, and PK are sequentially primarily transferred from the photosensitive drums 31 onto an intermediate transfer belt 12, serving as an intermediate transfer member, by primary transfer rollers 11 in a manner of overlapping each other. Adherents, such as residual toner, remaining on the photosensitive drums 31 are removed by cleaning units disposed in each of the image forming units PY, PM, PC, and PK, and are collected to a collection container 17.

The intermediate transfer unit 10 includes the intermediate transfer belt 12, a secondary transfer inner roller 13, a tension roller 14, and the like. The intermediate transfer belt 12 is wound around the secondary transfer inner roller 13, the tension roller 14, and the like, and is rotatably driven in an arrow R1 direction in FIG. 1. The tension roller 14 is urged toward an arrow T direction by an urging member such as a spring, and applies suitable tension to the intermediate transfer belt 12. The toner image borne by the intermediate transfer belt 12 is secondarily transferred onto the sheet S at a secondary transfer portion 15 formed by a secondary transfer roller 16 opposing the secondary transfer inner roller 13 and the intermediate transfer belt 12. Adherents, such as residual toner, remaining on the intermediate transfer belt 12 is removed by a belt cleaning unit 18, and is collected to the collection container 17. To be noted, the image forming section 3 forms the image on the sheet S, and is not limited to the intermediate transfer system as in this embodiment; thus, other image forming mechanisms such as an electrophotographic mechanism of a direct transfer system, an inkjet system, and the like may be employed. In addition, in this embodiment, the image forming section 3 forms a color image; however, it is not limited to this, and the image forming section 3 may be configured to form a monocolor image using a single-color toner.

The sheet S onto which the toner image has been transferred is conveyed to the fixing unit 4. The fixing unit 4 includes a heating film 20, serving as a fixing film, and a pressing roller 21 disposed opposite the heating film 20, and applies heat and pressure onto the toner image while nipping and conveying the sheet S. Thereby, the toner is melted and bonded, so that the image is fixed on the sheet S. The fixing unit 4 will be described below.

In parallel with the image forming process described above, the sheet feed unit 5 feeds the sheet S toward the image forming section 3. The sheet feed unit 5 includes a sheet feed cassette 50, serving as a sheet storage portion, and a sheet feed roller 51 which feeds the sheet S from the sheet feed cassette 50. The sheet S fed by the sheet feed roller 51 is conveyed toward a registration roller pair 60 of the conveyance unit 6 in a state of being separated from the other sheet S by a separation means such as a retard roller or a separation pad. To be noted, the sheet feed roller 51 is a sheet feed unit, and its configuration is not limited to rollers; for example, other mechanisms such as an air-feed system may also be employed. In addition, the sheet feed unit 5 includes the manual feed tray 52, which can be opened externally to the apparatus body 2, and a sheet feed roller 53 which feeds the sheet S stacked on the manual feed tray 52.

The registration roller pair 60 performs skew correction by abutting the sheet S while in a stationary state, and conveys the sheet S toward the secondary transfer portion 15 in synchronization with the timing of the image forming operation of the toner image in the image forming section 3. The sheet S, on which the image has been formed and fixed by passing through the secondary transfer portion 15 and the fixing unit 4, is conveyed to a conveyance roller pair 61 positioned downstream of the fixing unit 4 in the sheet conveyance direction.

In the sheet conveyance direction, a flap-shaped switching member 63, which directs the sheet S either toward a sheet discharge roller pair 62 or a duplex conveyance portion is disposed downstream of the conveyance roller pair 61. In a case of performing single sided printing, the sheet S conveyed by the conveyance roller pair 61 is guided toward a sheet discharge path 64 by the switching member 63. The sheet S is directed toward the sheet discharge roller pair 62 via the sheet discharge path 64, and is discharged to a sheet discharge tray 7 disposed on top of the apparatus body 2 by the sheet discharge roller pair 62.

In a case of performing duplex printing, the sheet S is guided to the duplex conveyance portion by the switching member 63. The duplex conveyance portion includes a switchback path 65, a reconveyance path 66, and a switchback roller pair 67. The sheet S guided by the switching member 63 is conveyed to the switchback path 65 by the rotation of the switchback roller pair 67 in a forward direction. When a trailing edge of the sheet S has passed through the switching member 63, the switching member 63 switches to a direction that guides the sheet S to the sheet discharge path 64, and the switchback roller pair 67 starts rotation in a reverse direction before the trailing edge of the sheet S passes through a nip portion. As described above, the duplex conveyance portion switchbacks the sheet S in the switchback path 65 to invert its front and back sides, conveys the sheet S in the reconveyance path 66 by a reconveyance roller pair 68, and again conveys the sheet S from the registration roller pair 60 to the image forming section 3. The sheet S having the image formed on the back side by the image forming section 3 is guided to the sheet discharge roller pair 62 by the switching member 63, and is discharged to the sheet discharge tray 7.

### Configuration of Fixing Unit

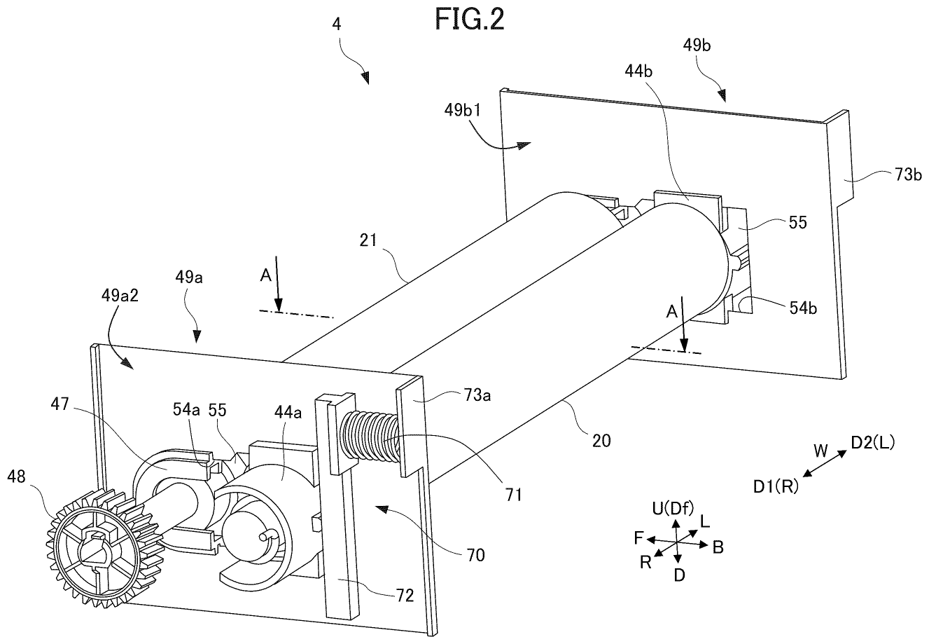

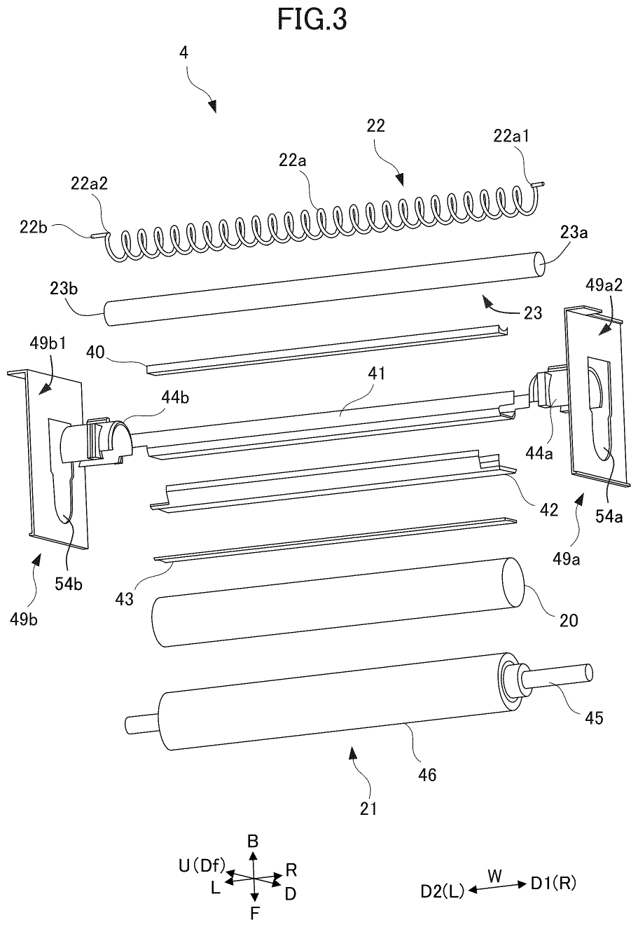

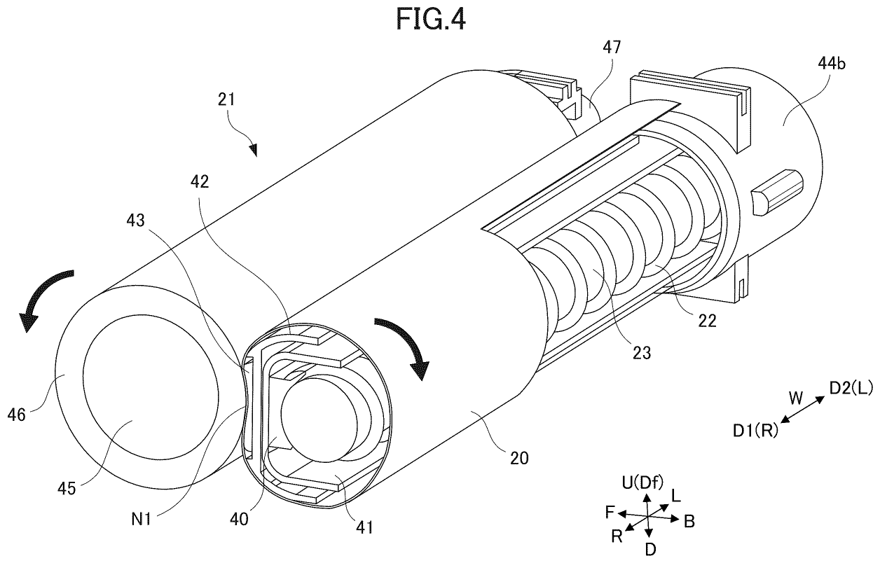

Next, using FIGS. 2 to 4, the configuration of the fixing unit 4 according to this disclosure will be described. The fixing unit 4 in this embodiment is a fixing unit employing an electromagnetic induction heating method. FIG. 2 is a schematic perspective view illustrating the fixing unit 4, and illustrates relationships among pressing mechanisms 70, the heating film 20, and the pressing roller 21. FIG. 3 is an exploded perspective view illustrating the fixing unit 4 disassembled into individual component units, and FIG. 4 is a perspective view illustrating a state taken along the line A-A of FIG. 2 for showing an internal structure of the fixing unit 4.

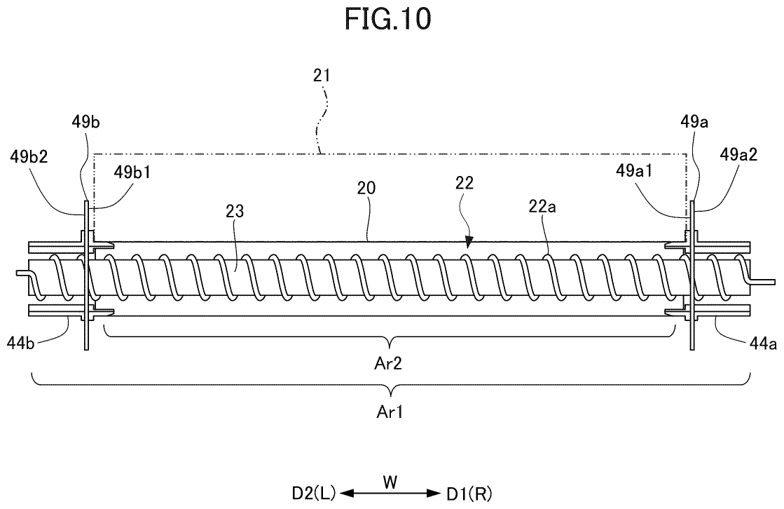

The fixing unit 4 is a unit that employs a method of heating an unfixed toner image, which has been transferred onto the sheet S, using the heating film 20, and includes the heating film 20, the pressing roller 21, and the pressing mechanisms 70. In addition, the fixing unit 4 includes a metallic first side plate 49a and a second side plate 49b arranged at both ends in the width direction W, and a frame, not shown, connecting the first and second side plates 49a and 49b. The first side plate 49a is disposed at a position deviated in the width direction W with respect to a sheet passing area Ar2 (refer to FIG. 10) where the sheet S passes by being nipped and conveyed in the sheet conveyance direction Df by the heating film 20 and the pressing roller 21. The second side plate 49b is disposed at a position deviated in the width direction W with respect to the sheet passing area Ar2 (refer to FIG. 10). These first and second side plates 49a and 49b, and the frame constitute a frame body of the fixing unit 4. The heating film 20, the pressing roller 21, and the pressing mechanisms 70 are each supported by the first and second side plates 49a and 49b.

The first side plate 49a includes a first inner surface 49a1 (refer to FIG. 10), which is an inner surface facing the heating film 20 in the second direction D2, and a first outer surface 49a2, which is an outer surface facing the first direction D1. The first outer surface 49a2 is a surface opposite to the first inner surface 49a1. The second side plate 49b includes a second inner surface 49b1, which faces the heating film 20 in the first direction D1, and a second outer surface 49b2 (refer to FIG. 10), which faces the second direction D2. In this embodiment, the term “inner surface” refers to a plane that faces a center side in the width direction W of the heating film 20 and is perpendicular to the width direction W. However, the inner surface is not limited to a plane perpendicular to the width direction W, and may also include surfaces inclined with respect to the width direction W, curved surfaces, end faces of convex portions, or the like. Similarly, the term “outer surface” refers to a plane that is disposed on a side opposite to the inner surface in the width direction W, faces a direction opposite to the heating film 20, and is perpendicular to the width direction W. However, the outer surface is not limited to a plane perpendicular to the width direction W, and may also include surfaces inclined with respect to the width direction W, curved surfaces, end faces of convex portions, or the like.

In the fixing unit 4, a substantial pressing force is required to ensure secure fixation of the toner image on the sheet S. Therefore, the frame body of the fixing unit 4 requires substantial structural strength, and the first and second side plates 49a and 49b, which support the heating film 20, the pressing roller 21, and the pressing mechanisms 70, onto which particularly high applied forces are exerted, are constructed from metallic members rather than resin-based members. In addition, in this embodiment, the first and second side plates 49a and 49b are formed from non-magnetic metals such as non-magnetic steel or nonmagnetic stainless steel utilizing, for example, austenitic stainless steels such as stainless steel 304 (SUS304 ) or stainless steel 316 (SUS316 ).

Further, the fixing unit 4 includes a first flange member 44a supported by the first side plate 49a and a second flange member 44b supported by the second side plate 49b. These first and second flange members 44a and 44b rotatably support the heating film 20, and position and support a stay 41, described below.

The heating film 20 is an example of a rotary member, is constituted by a film including a conductive layer, is formed in a tubular shape, and is rotatably supported by the first and second flange members 44a and 44b. A longitudinal direction of the heating film 20 corresponds to the width direction W. The heating film 20 utilizes a base layer of heat-resistant resin, such as polyamide-imide or polyimide, with the conductive layer disposed on the base layer. The conductive layer is composed of conductive materials such as copper or silver. A protective layer, composed of heat-resistant resin identical to that of the base layer, is formed on the conductive layer. An elastic layer composed of a material such as silicone rubber is formed on the protective layer, and a release layer composed of a material such as fluororesin is formed on the elastic layer. Since the heating film 20 only requires at least a layer composed of the conductive materials, it is also acceptable to form the elastic and release layers on a cylinder, serving as a heat generation layer, which utilizes metal such as nickel or stainless steel as a material.

A conductive coil 22 is disposed in an internal space of the heating film 20. The conductive coil 22 includes a helical portion 22a and conductive portions 22b. When a high-frequency current is applied to the conductive coil 22, an induced current is generated in the conductive layer of the heating film 20, and the conductive layer generates heat. In an internal space of the helical portion 22a of the conductive coil 22, a magnetic core 23 is disposed.

The helical portion 22a is formed by being helically wound around the magnetic core 23, and an axial direction of its helical axis is substantially parallel to the longitudinal direction (width direction W) of the heating film 20. The helical portion 22a includes a first end 22a2 in the width direction W, and a second end 22a1 on a side opposite to the first end 22a2. Here, a direction from the first end 22a2 to the second end 22a1 along the width direction W is referred to as the first direction D1, and the opposite direction is referred to as the second direction D2. The conductive portions 22b are formed in a shape that extends parallel to the width direction W from both the ends of the helical portion 22a outward in the width direction W. The conductive portions 22b are connected to a control electrical circuit or the like via a cable or the like, not shown. The magnetic core 23 is configured to guide magnetic flux lines of an alternating magnetic field. The conductive coil 22 is formed, for example, from a litz wire made by twisting fine wire strands, or the like. An insulation member, not shown, made of heat-resistant resin or the like is interposed between the magnetic core 23 and the conductive coil 22 to insulate both elements from each other.

The magnetic core 23 is mounted and held on a holding member 40 made of resin by adhesive bonding or the like. The holding member 40 is beneficially formed from heat-resistant resin such as liquid crystal polymer (LCP) or polyphenylene sulfide (PPS). By forming the holding member 40 from heat-resistant resin, it is possible to suppress the thermal deformation and degradation of the magnetic core 23 and the conductive coil 22. As illustrated in FIG. 3, the magnetic core 23 has a finite configuration (a configuration that does not form a loop) possessing both end portions in the width direction W. Therefore, magnetic flux lines induced by the magnetic core 23 form an open magnetic circuit.

The holding member 40 is supported by the stay 41. The stay 41 is beneficially made of high Young's modulus materials such that urging forces from the pressing mechanisms 70 are uniformly transmitted across the longitudinal direction of a nip portion N1. In this embodiment, the stay 41 is fabricated from non-magnetic metal such as non-magnetic steel or non-magnetic stainless steel, namely, for example, utilizing austenitic stainless steel such as SUS304 or SUS316. With this configuration, it is possible to suppress eddy current generation even when there are magnetic flux lines passing through the stay 41. Both end portions in the width direction of the stay 41 are positioned and supported by the first and second flange members 44a and 44b. That is, the magnetic core 23 and the conductive coil 22 are indirectly supported by the stay 41.

The magnetic core 23 is constituted, for example, as a ferromagnetic body composed of high magnetic permeability oxides or alloys such as sintered ferrite, ferrite resin, amorphous alloys of non-crystalline metals, or permalloy. The magnetic core 23 has a finite configuration in an axial direction of the core. It is beneficial that the magnetic core 23 has the largest possible cross-sectional area to the extent that can be accommodated within the heating film 20. In this embodiment, the magnetic core 23 is formed in a cylindrical shape; however, it is not limited to this, and a rectangular column shape or the like may be employed.

The stay 41 is an example of a metal member disposed in the internal space of the heating film 20, and serves as a member that uniformly transmits the urging forces, which are required for forming the nip portion N1 for nipping and conveying the sheet S, from the pressing mechanisms 70 across the longitudinal direction of the fixing unit 4. In the front-back direction, a support member 42 is disposed on the stay 41 on a side opposite to the holding member 40 with respect to the stay 41. The support member 42 is beneficially fabricated from heat-resistant resin such as liquid crystal polymer (LCP) or polyphenylene sulfide (PPS). By fabricating the support member 42 from heat-resistant resin, heat transfer from the heating film 20 to the stay 41 can be suppressed; thereby, it becomes possible to efficiently utilize heat generated by the heating film 20 in a fixing process.

The support member 42 supports a sliding contact plate 43. The sliding contact plate 43 is an example of a sliding contact member, interposed between the stay 41 and the heating film 20, and is supported by the stay 41 via the support member 42. The sliding contact plate 43 is in contact with an inner circumferential surface of the heating film 20, and the heating film 20 rotates while sliding against the sliding contact plate 43. That is, the support member 42 is interposed between the stay 41 and the sliding contact plate 43, is supported by the stay 41, and supports the sliding contact plate 43. The sliding contact plate 43 requires smoothness to suppress the internal surface wear of the heating film 20. In this embodiment, the sliding contact plate 43 is fabricated from materials such as aluminum alloy or heat-resistant resin, and is configured as a member with enhanced smoothness at a sliding surface with the heating film 20. In addition, to further enhance slidability, surface treatment such as fluororesin coating or the like may be applied to the sliding contact plate 43.

The first and second flange members 44a and 44b are arranged to face end faces of the heating film 20 in the width direction W, and restrict the lateral displacement of the heating film 20 in the width direction W. The first and second flange members 44a and 44b each include a semi-cylindrical portion. The heating film 20 is mounted on an outer circumference of the semi-cylindrical portion. By bringing the inner circumferential surface of the heating film 20 into sliding contact with outer circumferential surfaces of the semi-cylindrical portions, the heating film 20 rotates while being guided by the semi-cylindrical portions.

The first side plate 49a includes an opening portion 54a that penetrates through the plate in the width direction W. In the opening portion 54a, the first flange member 44a is supported so as to be movable in the front-back direction. Similarly, the second side plate 49b includes an opening portion 54b that penetrates through the plate in the width direction W. In the opening portion 54b, the second flange member 44b is supported so as to be movable in the front-back direction. That is, the heating film 20 is configured to move in the front-back direction with respect to the opening portions 54a and 54b of the first and second side plates 49a and 49b in a state of being supported by the first and second flange members 44a and 44b. Thereby, the heating film 20 is configured to apply pressure against the pressing roller 21.

The pressing roller 21 is an example of an opposing member, and is brought into contact with an outer circumferential surface of the heating film 20 to form the nip portion N1 with the heating film 20, and is rotatable around a rotational axis as a center. The rotational axis extends in the width direction W, which corresponds to an axial direction. The pressing roller 21 includes a shaft core portion 45, and an elastic layer 46, which is disposed around the shaft core portion 45 and possesses heat-resistant characteristics using materials such as silicone rubber. Both end portions of the shaft core portion 45 are rotatably supported in the opening portions 54a and 54b of the first and second side plates 49a and 49b via bearings 47. An outer circumferential surface (surface) of the pressing roller 21 is disposed so as to come into contact with the outer circumferential surface (surface) of the heating film 20. A gear 48 is fixedly mounted to the end portion of the shaft core portion 45 on a first direction D1 side (first direction side).

The pressing mechanisms 70 are disposed at both the end portions in the width direction. The pressing mechanism 70 on the first direction D1 side includes an urging spring 71 formed of a compression spring, and a pressing plate 72. The pressing plate 72 is disposed in contact with a rear portion of the first flange member 44a, and is configured to pivot or move in the front-back direction. The first side plate 49a includes a bent portion 73a that is bent in the first direction D1 from an upward direction U side of a backward direction B side of the first side plate 49a at a position in the backward direction B from the pressing plate 72. The urging spring 71 is disposed between the bent portion 73a of the first side plate 49a and the pressing plate 72, and, by urging the pressing plate 72 in the forward direction F, applies pressure to the heating film 20 toward the pressing roller 21 via the first flange member 44a, the stay 41, the support member 42, and the sliding contact plate 43. That is, the urging spring 71 is an example of an urging member, and urges the first flange member 44a toward the pressing roller 21.

Similarly, the pressing mechanism 70, not shown, on a second direction D2 side includes an urging spring formed of a compression spring, and a pressing plate. The pressing plate is disposed in contact with a rear portion of the second flange member 44b, and is configured to pivot or move in the front-back direction. The second side plate 49b includes a bent portion 73b that is bent in the second direction D2 from the upward direction U side of the backward direction B side of the second side plate 49b at a position in the backward direction B from the pressing plate. The urging spring is disposed between the bent portion 73b of the second side plate 49b and the pressing plate, and, by urging the pressing plate in the forward direction F, applies pressure to the heating film 20 toward the pressing roller 21 via the second flange member 44b, the stay 41, the support member 42, and the sliding contact plate 43.

As a result, the elastic layer 46 of the pressing roller 21 is compressed and elastically deformed via the heating film 20; thereby, the nip portion N1 of a predetermined width necessary for the thermal fixing of the unfixed toner image is formed between the surfaces of the heating film 20 and the pressing roller 21. By transmitting a driving force of a motor, not shown, disposed in the apparatus body 2 to the gear 48, the pressing roller 21 is rotatably driven in an arrow direction in FIG. 4. The heating film 20 is driven to rotate by the rotation of the pressing roller 21 with its inner circumferential surface maintained in sliding contact with the sliding contact plate 43. After the heating film 20 generates heat through induction heating and reaches the desired temperature, with the sheet S being nipped and conveyed at the nip portion N1, heat from the heating film 20 and pressure at the nip portion N1 are applied to the sheet S onto which the unfixed toner image has been transferred. Thereby, the toner image is thermally fixed on the sheet.

In this embodiment, the first and second side plates 49a and 49b rotatably support both the heating film 20 and the pressing roller 21. However, it is not limited to this, and the first and second side plates 49a and 49b may be configured to rotatably support at least one of the heating film 20 and the pressing roller 21. Alternatively, the first and second side plates 49 and 49b may not serve as members that rotatably support the heating film 20 and the pressing roller 21; instead, the heating film 20 and the pressing roller 21 may be rotatably supported by other members.

### Heat Generation Mechanism of Fixing Unit

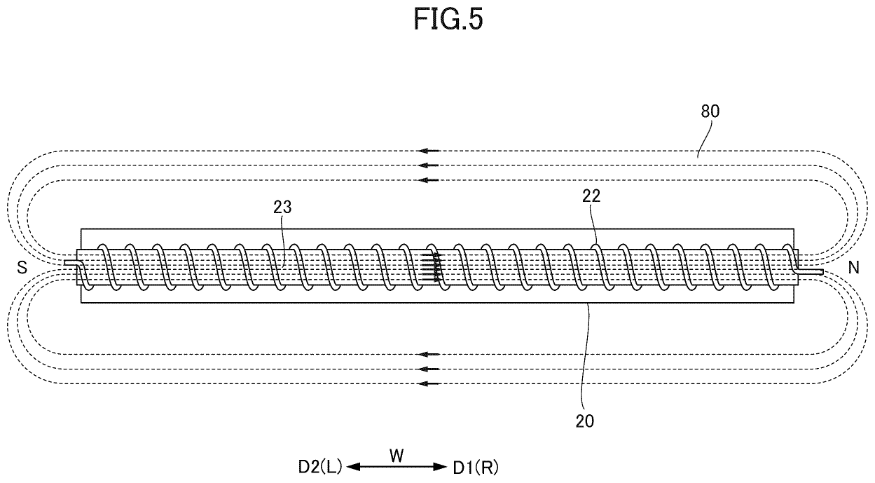

Next, using FIG. 5, a heat generation mechanism of the fixing unit 4 of this embodiment will be described. A plurality of magnetic flux lines 80, generated by applying an alternating current to the conductive coil 22, pass through the interior of the magnetic core 23 in a bus bar direction (direction from the south-pole (S-pole) toward the north-pole (N-pole)) of the heating film 20. By optimizing a cross-sectional area of the magnetic core 23 occupying the internal space of the heating film 20 when viewed in the width direction W, and the like, the magnetic flux lines 80 exit outward the heating film 20 from a side of a first end (N-pole) of the magnetic core 23 and return to a side of a second end (S-pole) of the magnetic core 23. That is, almost all (equal to or more than 90%, at least equal to or more than 70%) of the magnetic flux lines pass through an external region of the heating film 20 (the magnetic flux lines are configured to be prevented from entering the conductive layer of the heating film 20). In the heating film 20, an induced electromotive force is generated so as to create a magnetic flux that cancels a magnetic flux produced by the conductive coil 22; thereby, an electrical current is induced in a circumferential direction of the conductive layer. The conductive layer generates heat due to Joule heating caused by the electrical resistance of the conductive layer and the induced current. The magnitude of the induced electromotive force generated in the heating film 20 is proportional to both the differential change in magnetic flux density per unit time passing through the interior of the heating film 20 and the number of coil windings.

### Characteristics of Magnetic Flux Lines

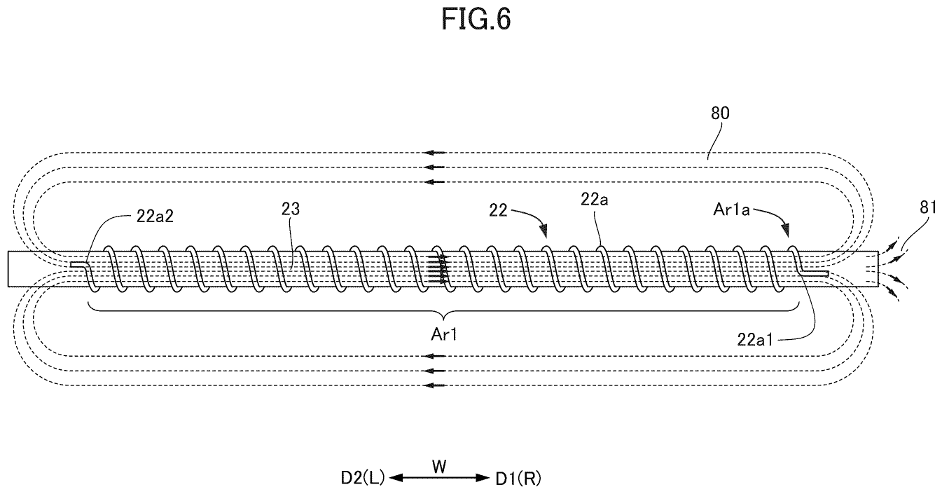

Next, using FIGS. 6 to 9, characteristics of the magnetic flux lines 80 will be described. As illustrated in FIG. 6, a description will be given for a case where the end portions of the magnetic core 23 extend outward beyond the end portions of the helical portion 22a of the conductive coil 22. A region, in which a region (section) between the first end 22a2 and the second end 22a1 of the helical portion 22a, and a region (section) where the magnetic core 23 is present, overlap in the width direction W is referred to as an overlap region Ar1. In this case, the magnetic flux lines 80 exiting outward from the N-pole side are predominantly generated from an end portion Ar1a on the N-pole side of the overlap region Ar1. However, while magnetic flux lines 81 are also generated from an end portion 23a on the N-pole side of the magnetic core 23, their number is less compared to that of magnetic flux lines 80.

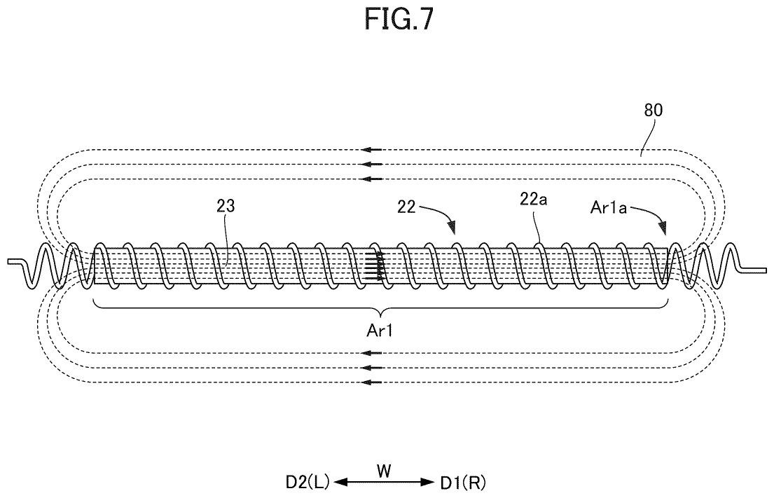

Next, as illustrated in FIG. 7, a description will be given for a case where the end portions of the helical portion 22a extend outward beyond the end portions of the magnetic core 23. In this case, the magnetic flux lines 80 exiting outward from the N-pole side are most predominantly generated from the end portion Ar1a on the N-pole side of the overlap region Ar1, and minimal flux generation occurs from the end portion of the helical portion 22a.

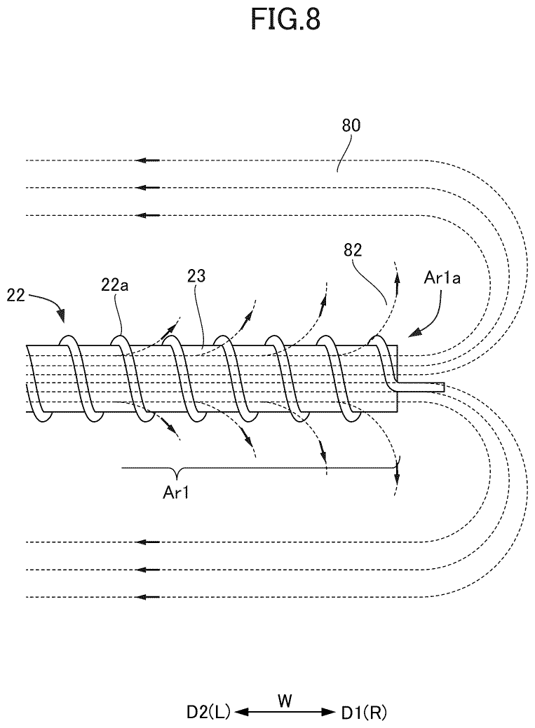

In addition, as illustrated in FIG. 8, even at locations other than the end portion Ar1A on the N-pole side of the overlap region Ar1, there also are, for example, magnetic flux lines 82 that leak from locations adjacent to the end portion Ar1a in the first direction D1. However, the number of such magnetic flux lines 82 is not as many as that of magnetic flux lines 80 generated from the end portion Ar1A on the N-pole side, and the number further decreases toward the second direction D2.

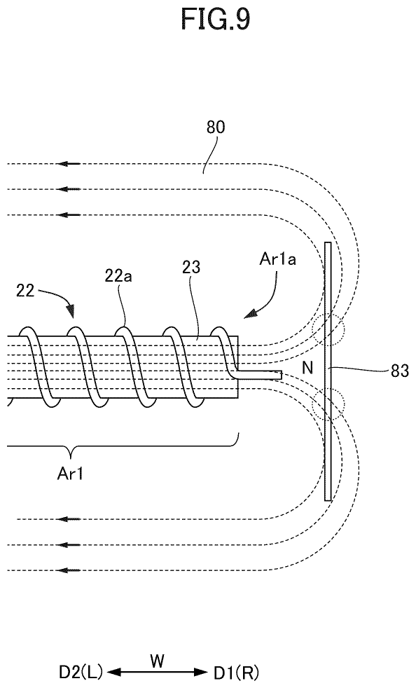

In addition, as illustrated in FIG. 9, when a portion of the magnetic flux lines 80 exited outward from the end portion Ar1a on the N-pole side of the overlap region Ar1 passes and penetrates (extends) through a metal plate 83 during a return path to the end portion on the S-pole side, eddy current generation occurs in the metal plate 83. When the eddy current generation occurs, the metal plate 83 generates heat, and reaches an elevated temperature. Further, since the eddy current generation requires unnecessary power consumption, also an increased current becomes necessary to heat the heating film 20 to the desired temperature, which may result in increased power consumption. Therefore, it is desired that, during the return path to the end portion on the S-pole side, the magnetic flux lines 80 exited outward from the end portion Ar1a on the N-pole side of the overlap region Ar1 pass through as few metal plates, such as the first and second side plates 49a and 49b, and the stay 41, as possible.

### Arrangement of Magnetic Core and Conductive Coil

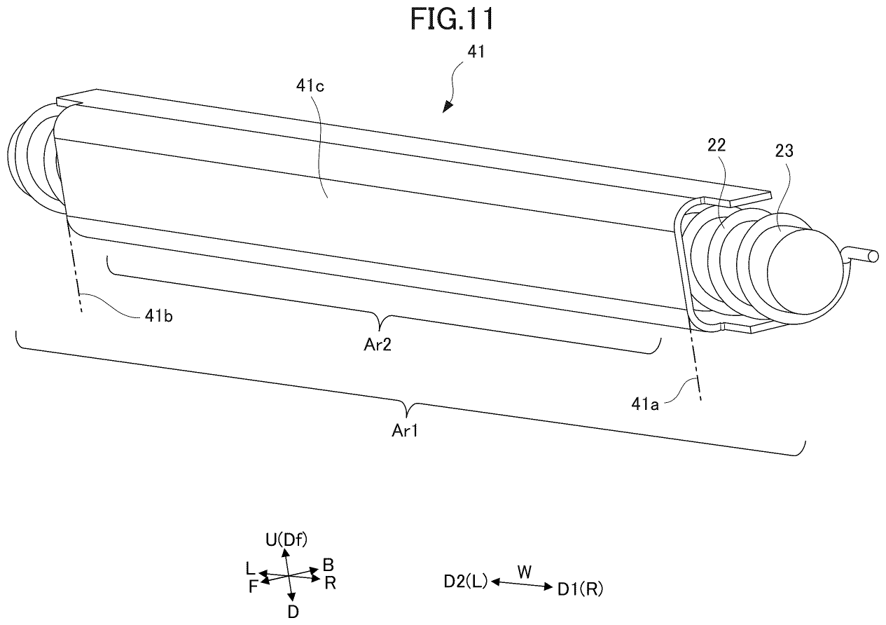

Next, using FIGS. 10 and 11, the arrangement of the magnetic core 23 and the conductive coil 22 mounted in the fixing unit 4 of this embodiment will be described. As illustrated in FIG. 10, in this embodiment, the magnetic core 23 is configured to extend to a length that overlaps both the end portions of the helical portion 22a of the conductive coil 22. The helical portion 22a of the conductive coil 22 and the magnetic core 23 pass through the interior of the first and second flange members 44a and 44b, and, in the width direction W, are configured to extend to lengths that reach beyond the first and second side plates 49a and 49b. That is, the magnetic core 23 and the conductive coil 22 penetrate (extend) through the opening portions 54a and 54b, and the overlap region Ar1 of the helical portion 22a of the conductive coil 22 and the magnetic core 23 includes a region that projects beyond a first outer surface 49a2 of the first side plate 49a in the first direction D1. Similarly, the overlap region Ar1 includes a region that projects beyond a second outer surface 49b2 of the second side plate 49b in the second direction D2. As described above, in this embodiment, the overlap region Ar1 includes a region that projects beyond terminal ends of both the elastic layer 46 of the pressing roller 21 and the heating film 20 in the first direction D1, and a region that projects beyond terminal ends in the second direction D2.

As illustrated in FIG. 11, the stay 41 requires high strength to withstand the urging forces from the pressing mechanisms 70, and is therefore configured as a substantially U-shaped metallic member when viewed in the width direction W. In other words, the stay 41 becomes a metallic member that is disposed in closest proximity to the magnetic core 23 and the conductive coil 22. In addition, in this embodiment, the stay 41 is disposed to enclose the magnetic core 23 along the width direction, and has a shape that opens in a direction intersecting with the width direction (here, backward direction B). Thereby, in comparison to a case where the entire circumference is enclosed without an opening, the magnetic flux lines generated from the magnetic core 23 and the conductive coil 22 and penetrating through the stay 41 can be reduced; therefore, it is possible to suppress the eddy current generation in the stay 41.

A bottom surface portion 41c of the stay 41 includes a first terminal end portion 41a, which serves as a downstream end in the first direction D1, and a second terminal end portion 41b, which serves as a downstream end in the second direction D2. The overlap region Ar1 includes a region that projects beyond the first terminal end 41a in the first direction D1, and a region that projects beyond the second terminal end 41b in the second direction D2. That is, the first and second terminal end portions 41a and 41b in the with direction W of the bottom surface portion 41c of the stay 41 are positioned inside the overlap region Ar1 of the helical portion 22a of the conductive coil 22 and the magnetic core 23.

As illustrated in FIG. 10, the overlap region Ar1 extends outward in the width direction W beyond the sheet passing area Ar2 where the sheet S passed by being nipped and conveyed in the sheet conveyance direction Df by the heating film 20 and the pressing roller 21. On the other hand, the sheet passing area Ar2 is located inside the first and second side plates 49a and 49b in the width direction W, and is not configured to have an unnecessarily increased size in the width direction W. As described above, in the width direction W, both the end portions of the overlap region Ar1 extend outward with respect to both the end portions of the elastic layer 46 of the pressing roller 21 and the heating film 20. In addition, as illustrated in FIG. 11, the first terminal end 41a is disposed at a position deviated in the width direction W with respect to the sheet passing area Ar2, and the second terminal end 41b is disposed at a position deviated in the width direction W with respect to the sheet passing area Ar2.

### Flow of Magnetic Flux Lines

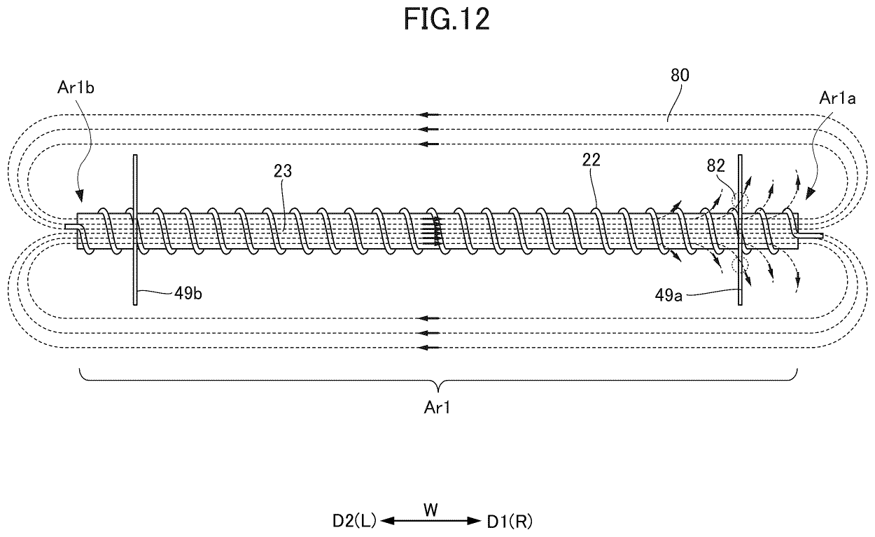

Next, using FIG. 12, the flow of the magnetic flux lines in this embodiment will be described. As illustrated in FIG. 12, the end portion Ar1a on the N-pole side and an end portion Ar1b on the S-pole side in the width direction of the overlap region Ar1 are respectively positioned outside the first and second side plates 49a and 49b. Therefore, the most predominant magnetic flux lines 80 exited from the end portion Ar1a of the overlap region Ar1 can circulate without penetrating through the first and second side plates 49a and 49b. In other words, it is possible to suppress the eddy current generation resulting from penetration through the first and second side plates 49a and 49b; thereby, it is possible to reduce unnecessary power consumption and reduce losses in the induced electromotive force generated in the heating film 20.

In addition, a portion of the magnetic flux lines 82 that leak from the area adjacent to the inner side of the end portion Ar1a penetrate through the first and second side plates 49a and 49b after leaking from the inner side of the first and second side plates 49a and 49b; accordingly, there is a likelihood of the eddy current generation and the occurrence of power losses. However, the number of magnetic flux lines that penetrate through the first and second side plates 49a and 49b is not as substantial as the number of magnetic flux lines 80, which are generated from the end portion Ar1a; therefore, the overall loss of the induced electromotive force is not significant.

In addition, in this embodiment, the opening portion 54a of the first side plate 49a and the opening portion 54b of the second side plate 49b are each provided with a gap portion 55 disposed with a clearance with respect to the magnetic core 23 and conductive coil 22 which are penetrating through (refer to FIG. 2). Therefore, a portion of the magnetic flux lines 82 that leak from the area adjacent to the inner side of the end portion Ar1a passes through the gap portions 55, and can avoid the penetration through the first and second side plates 49a and 49b. This also makes it possible to reduce the likelihood of the eddy current generation in the first and second side plates 49a and 49b and the occurrence of subsequent power losses.

In addition, the first and second terminal end portions 41a and 41b in the width direction W of the bottom surface portion 41c of the stay 41, which is the metal member positioned in the closest proximity to the magnetic core 23 and the conductive coil 22, are located inside the overlap region Ar1. Therefore, the most predominant magnetic flux lines 80 exiting from the end portion Ar1a of the overlap region Ar1 can circulate without penetrating through the bottom surface portion 41c in the same manner as in the case with the first and second side plates 49a and 49b. Therefore, it is possible to also mitigate losses in the induced electromotive force generated in the heating film 20.

### First Comparative Example

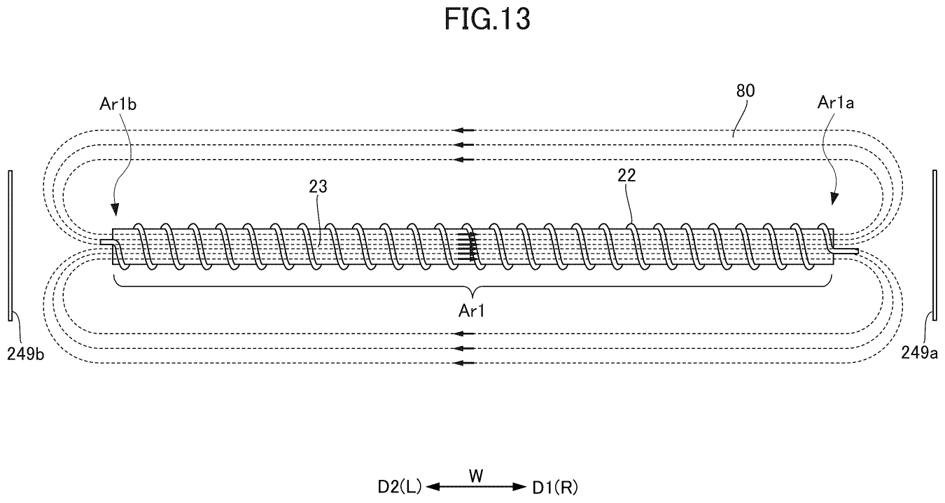

Next, using FIG. 13, a first comparative example including a configuration different from the first embodiment will be described. As illustrated in FIG. 13, in the first comparative example, different from the first embodiment, first and second side plates 249a and 249b are disposed externally with respect to the end portions Ar1a and Ar1b of the overlap region Ar1. Also in this case, if the first and second side plates 249a and 249b are sufficiently spaced apart from circulation paths of the magnetic flux lines exiting from the end portion Ar1a of the overlap region Ar1, the magnetic flux lines 80 can circulate without penetrating through the first and second side plates 249a and 249b. Therefore, with respect to the prevention of losses in the induced electromotive force, there exists a possibility to achieve effects equivalent to those of the first embodiment.

However, in such an arrangement, to ensure that the magnetic flux lines 80 do not penetrate through the first and second side plates 249a and 249b, it is necessary to position the first and second side plates 249a and 249b with substantial outward separation in the width direction W. Therefore, the size of the frame body of the fixing unit 4, constituted by the first and second side plates 249a and 249b and a frame, not shown, connecting these side plates, is enlarged compared to the first embodiment. Further, since the heating film 20 and the pressing roller 21 are supported by the first and second side plates 249a and 249b, it becomes necessary to substantially extend the length of the heating film 20 and the pressing roller 21 with respect to the sheet passing area Ar2. Thereby, so as to achieve the same effects as the first embodiment, the overall size of the fixing unit 4 increases, which may result in increased costs and the enlargement of the image forming apparatus 1.

### Second Comparative Example

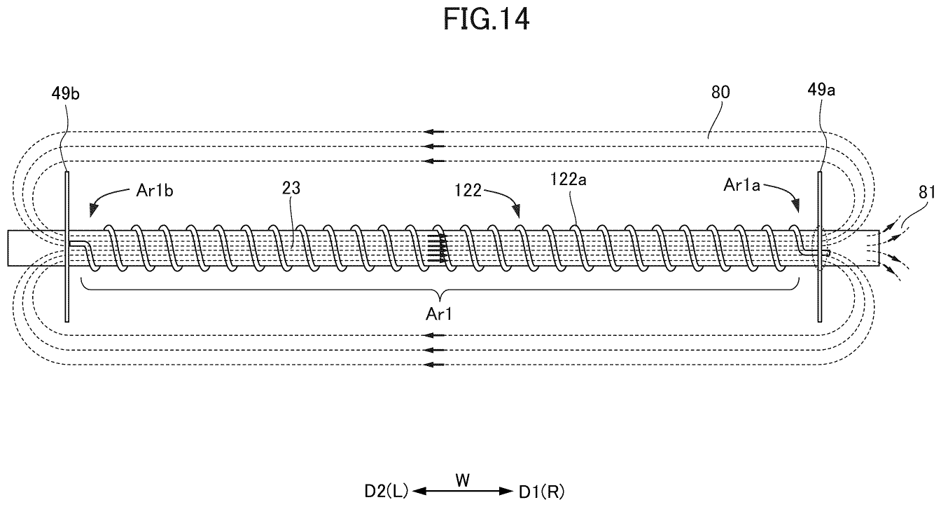

Next, using FIG. 14, a second comparative example including a configuration different from the first embodiment will be described. As illustrated in FIG. 14, in the second comparative example, the magnetic core 23 passes through the interior of the first and second side plates 49a and 49b in the same manner as the first embodiment (refer to FIG. 4), and has a length that extends outwardly beyond the first and second side plates 49a and 49b in the width direction W. On the other hand, the helical portion 22a of the conductive coil 22 has a length shorter than the spacing between the first and second side plates 49a and 49b, which differs from the first embodiment. With this configuration arrangement, the magnetic flux lines 81 generated from the end portion of the magnetic core 23 can circulate without penetrating through the first and second side plates 49a and 49b.

However, the magnetic flux lines 80 exiting from the end portion Ar1a of the overlap region Ar1 are more numerous than the magnetic flux lines 81, and the majority of the magnetic flux lines 80 penetrate through the first and second side plates 49a and 49b; therefore, there is a likelihood that significant eddy current generation may occur in the first and second side plates 49a and 49b. As a result, the first and second side plates 49a and 49b generate heat and reaches an elevated temperature, and the eddy current generation results in unnecessary power consumption. Therefore, a higher current becomes necessary to heat the heating film 20 to the desired temperature, which results in increased power consumption and prevents the achievement of the same effects as in the first embodiment.

### Effects Achieved by First Embodiment

According to this embodiment, the end portions Ar1a and Ar1b of the overlap region Ar1 are extended outward beyond the first and second side plates 49a and 49b. That is, the overlap region Ar1 includes the region that projects beyond the first outer surface 49a2 in the first direction D1, and the region that projects beyond the second outer surface 49b2 in the second direction D2. With this configuration, losses in the induced electromotive force generated in the heating film 20 can be suppressed without causing unnecessary heat generation in the first and second side plates 49a and 49b; thus, it is possible to improve the heat generation efficiency of the heating film 20. In addition, since the first and second side plates 49a and 49b are fabricated from metal, adequate frame structural strength capable of withstanding compressive forces can be achieved. Therefore, the fixing unit 4, which can improve the heat generation efficiency of the heating film 20 can be realized in a compact configuration without causing the enlargement of the apparatus and increased costs.

In addition, according to this embodiment, the first and second terminal end portions 41a and 41b in the width direction W of the bottom surface portion 41c of the stay 41 are positioned inside the overlap region Ar1. Therefore, the magnetic flux lines 80 exiting from the end portion Ar1a of the overlap region Ar1 can circulate without penetrating through the bottom surface portion 41c in the same manner as in the case with respect to the first and second side plates 49a and 49b. Therefore, losses in the induced electromotive force generated in the heating film 20 can also be reduced.

To be noted, in this embodiment described above, the overlap region Ar1 includes the region that projects beyond the first outer surface 49a2 of the first side plate 49a in the first direction D1, and the region that projects beyond the second outer surface 49b2 of the second side plate 49b in the second direction D2. However, it is not limited to this, and, for example, it is acceptable that the overlap region Ar1 is configured to include a region that projects beyond the first inner surface 49a1 of the first side plate 49a in the first direction D1, and a region that projects beyond the second inner surface 49b1 of the second side plate 49b in the second direction D2. That is, the end portions Ar1a and Ar1b of the overlap region Ar1 are not limited to project outward from the first and second side plates 49a and 49b, and are configured to be position inside the opening portions 54a and 54b without projecting outward from the first and second side plates 49a and 49b. Also in this case, since the predominant magnetic flux lines 80 generating from the end portion Ar1a do not pass through the first and second side plates 49a and 49b, it is possible to suppress losses in the induced electromotive force generated in the heating film 20, and is possible to improve the heat generation efficiency of the heating film 20.

In addition, in this embodiment, the overlap region Ar1 projects outward in the width direction W with respect to both the first and second side plates 49a and 49d; however, it is not limited to this. For example, the overlap region Ar1 may be configured to project outward in the width direction W with respect to only one of the first and second side plates 49a and 49b. Also in this case, in the side plate with respect to which the overlap region Ar1 projects outward in the width direction W, it is possible to suppress the passage of the magnetic flux lines 80.

In addition, in this embodiment, the overlap region Ar1 includes the region that projects beyond the first terminal end portion 41a of the bottom surface portion 41c of the stay 41 in the first direction D1, and the region that projects beyond the second terminal end portion 41b in the second direction D2; however, it is not limited to this. For example, both the ends of the overlap region Ar1 in the width direction W may be aligned with the first and second terminal end potions 41a and 41b of the bottom surface portion 41c of the stay 41. In addition, only one end of the overlap region Ar1 in the width direction W may be aligned with the first or second terminal end 41a or 41b. That is, the overlap region Ar1 includes a region that overlaps at least the first or second terminal end portion 41a or 41b. Also in this case, the predominant magnetic flux lines 80 exiting from the end portion Ar1a of the overlap region Ar1 can circulate without penetrating through the bottom surface portion 41c in the same manner as in the case with respect to the first and second side plates 49a and 49b.

In addition, in this embodiment, the overlap region Ar1 projects outward in the width direction W with respect to the first and second terminal end portions 41a and 41b of the bottom surface portion 41c of the stay 41; however, it is not limited to this. For example, the overlap region Ar1 may be configured to project outward in the width direction W with respect to only one of the first and second terminal end portions 41a and 41b. Also in this case, in the terminal end portion with respect to which the overlap region Ar1 projects outward in the width direction W, it is possible to suppress the passage of the magnetic flux lines 80.

### Second Embodiment

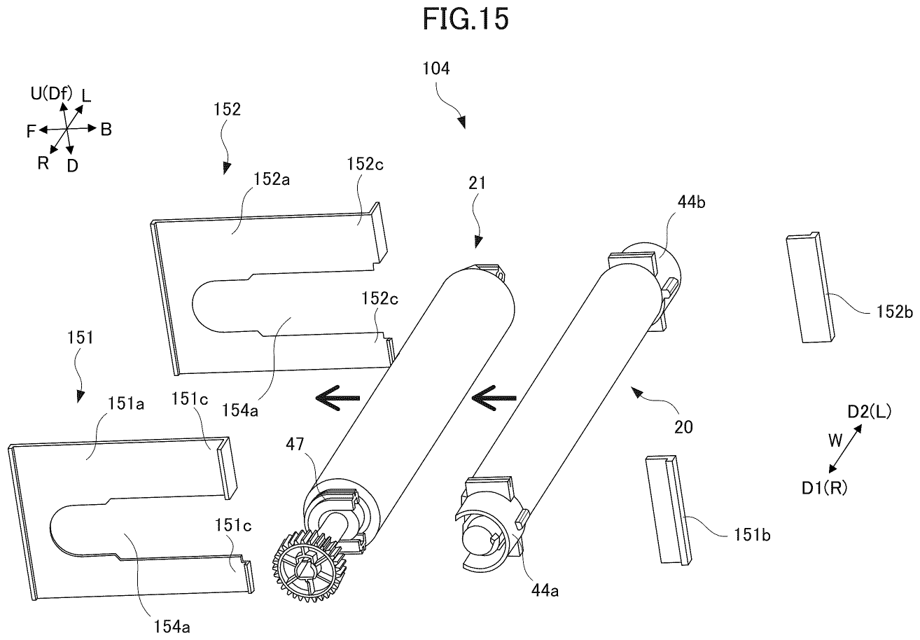

Next, using FIGS. 15 to 18, a fixing unit 104 of a second embodiment of this disclosure will be described. In the second embodiment, the configurations of the first and second side plates 49a and 49b are modified. Therefore, for configurations similar to the first embodiment, description will be provided by omitting illustration, or putting the same reference characters in the drawings.

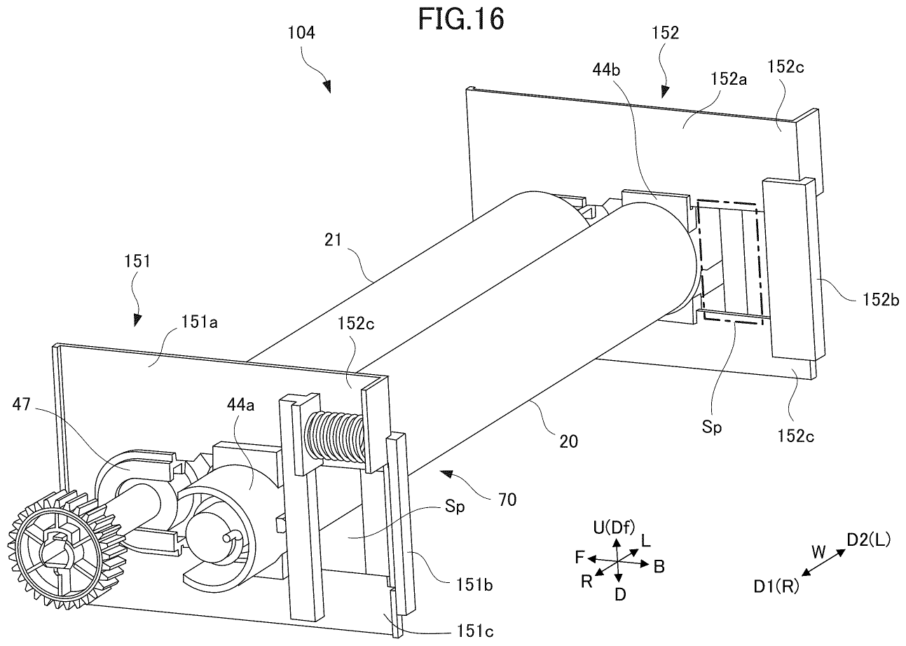

As illustrated in FIGS. 15 and 16, a first side plate 151 of this embodiment includes a first frame plate 151a and a first reinforcement member 151b. The first frame plate 151a is an example of a first member, and includes two terminal end portions 151c which, when viewed in the width direction W, form a U-shape that opens in an intersecting direction (for example, backward direction B) intersecting with the width direction, and face the same direction in the backward direction B. The first reinforcement member 151b is an example of a second member, and connects the two terminal end portions 151c of the first frame plate 151a. An opening portion 154a of the first side plate 151 is formed by being surrounded by the first frame plate 151a and the first reinforcement member 151b. To be noted, in this embodiment, the first side plate 151 is configured to include two members: the first frame 115a and the first reinforcement member 151b; however, it is not limited to this, and the first side plate 151 may be formed by combining equal to or more than three members. That is, the opening portion 154a is formed by being at least partially enclosed by the first frame plate 151a and the first reinforcement member 151b.

Similarly, a second side plate 152 of this embodiment includes a second frame plate 152a and a second reinforcement member 152b. The second frame plate 152a includes two terminal end portions 152c which, when viewed in the width direction W, form a U-shape that opens in an intersecting direction (for example, backward direction B) intersecting with the width direction, and face the same direction in the backward direction B. The second reinforcement member 152b connects the two terminal end portions 152c of the second frame plate 152a. An opening portion 154a of the second side plate 152 is formed by being surrounded by the second frame plate 152a and the second reinforcement member 152b.

In this embodiment, the first and second frame plates 151a and 152a are constructed from non-magnetic metal such as non-magnetic steel or non-magnetic stainless steel, and, for example, are fabricated from SUS304 or SUS316 which are austenitic stainless steel. In addition, positional relationships among the overlap region Ar1 of the magnetic core 23 and the helical portion 22a of the conductive coil 22 of this embodiment and the first and second side plate 151 and 152 are configured to be similar to the first embodiment. That is, the end potions Ar1a and Ar1b of the overlap region Ar1 are extended outward beyond the first and second side plates 151 and 152.

When assembling the fixing unit 104, first, the bearings 47, which support both the end portions of the pressing roller 21, are inserted in the forward direction F toward bottom portions of the opening portions 154a through spaces between the terminal end portions 151c of the first frame plate 151a and between the terminal end portions 152c of the second frame plate 152a. Next, the first and second flange members 44a and 44b, which support both the end portions of the heating film 20, are inserted into the opening portions 154a. Thereby, the pressing roller 21 and the heating film 20 are positioned in the sheet conveyance direction Df.

Thereafter, the first reinforcement member 151b is mounted to and connected with the two terminal end portions 151c of the first frame plate 151a. The first reinforcement member 151b is fastened to the frame plate 151a with fixing screws, not shown. Similarly, the second reinforcement member 152b is mounted to and connected with the two terminal end portions 152c of the second frame plate 152a. The second reinforcement member 152b is fastened to the frame plate 152a with fixing screws, not shown. By disposing the first and second reinforcement members 151b and 152b, the deformation of the terminal end portions 151c of the first frame plate 151a and the terminal end portions 152c of the second frame plate 152a due to the urging forces of the pressing mechanisms 70 is suppressed.

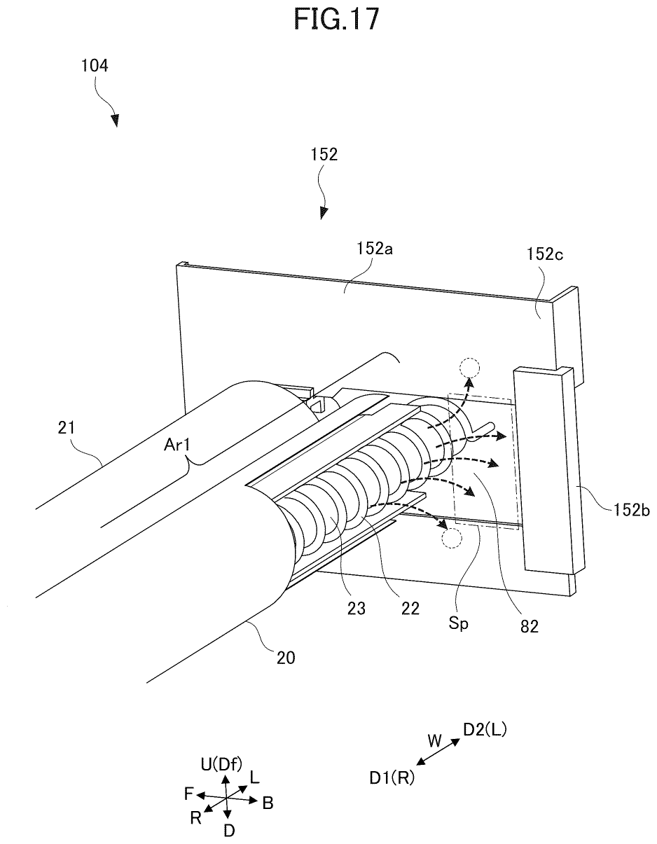

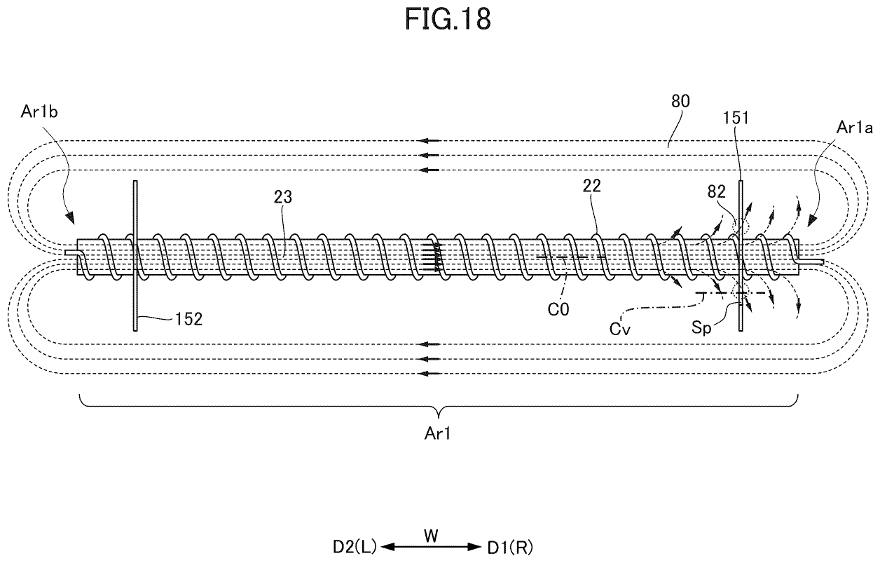

Here, gap portions Sp are disposed between the heating film 20 and first reinforcement member 151b, and between the heating film 20 and the second reinforcement member 152b, so that the first and second side plates 151 and 152 remain in an open configuration. As illustrated in FIGS. 17 and 18, the gap portions Sp are formed to extend outward beyond a virtual circle Cv, which is centered at a center CO of the magnetic core 23 and has a radius corresponding to a diameter of the magnetic core 23. That is, when viewed in the width direction W, part of the gap portion Sp is positioned outside the virtual circle Cv, which is centered at the center CO of the magnetic core 23 and has the radius corresponding to the diameter of the magnetic core 23.

### Flow of Magnetic Flux Lines

Next, using FIGS. 17 and 18, the flow of magnetic flux lines of this embodiment will be described. In this embodiment, the flow of the magnetic flux lines 80 generated from the end portion Ar1a of the overlap region Ar1 is similar to that described in the first embodiment illustrated in FIG. 12, and it is possible to suppress losses in the induced electromotive force generated in the heating film 20. In this embodiment, in addition, as illustrated in FIG. 17, since the first and second side plates 151 and 152 include the gap portions Sp, a portion of the magnetic flux lines 82 that leak from the center side in the width direction W with respect to the first and second side plates 151 and 152 can pass through the gap portions Sp. Thereby, the magnetic flux lines 82 can circulate without penetrating through the first and second side plates 151 and 152.

In addition, the first and second frame plates 151a and 152a of this embodiment are fabricated from non-magnetic metal materials. Therefore, at locations at which the magnetic flux lines 82 cannot pass through the gap portions Sp and penetrate through the first and second frame plates 151a and 152a, eddy current generation can be suppressed as compared to magnetic metal materials.

In addition, the first reinforcement member 151b of the first side plate 151 and the second reinforce member 152b of the second side plate 152 are each arranged with the gap portion Sp interposed with respect to the conductive coil 22. Therefore, since the magnetic flux lines 82 do not pass through the first and second reinforcement members 151b and 152b, the first and second reinforcement members 151b and 152b may be fabricated from magnetic metal materials, thus permitting the utilization of economical materials. To be noted, the first and second reinforcement members 151b and 152b may be fabricated from non-magnetic metal materials.

### Effects of Second Embodiment

According to this embodiment, the end portions Ar1a and Ar1b of the overlap region Ar1 are extended outward beyond the first and second side plates 151 and 152. Thereby, losses in the induced electromotive force generated in the heating film 20 can be suppressed without causing excessive heat generation in the first and second side plates 151 and 152, and the heat generation efficiency of the heating film 20 can be improved. In addition, since the first and second side plates 151 and 152 are fabricated from metal and are reinforced by the reinforcement members, it is possible to achieve frame structural strength capable of withstanding compressive forces. Therefore, the fixing unit 104, which can improve the heat generation efficiency of the heating film 20 can be realized in a compact configuration without causing the enlargement of the apparatus and increased costs.

In addition, by including the gap portions Sp in the first and second side plates 151 and 152, part of the magnetic flux lines 82 that leak from the center side in the width direction W with respect to the first and second side plates 151 and 152 can pass through the gap portions Sp. Thereby, the magnetic flux lines 82 are enabled to circulate without penetrating through the first and second side plates 151 and 152. In addition, the gap portions Sp are configured to extend outward beyond the virtual circle Cv, which is centered at the center CO of the magnetic core 23 and the radius corresponding to the diameter of the magnetic core 23. Therefore, the magnetic flux lines 82 can be sufficiently avoided, and it is possible to suppress losses in the induced electromotive force in a highly efficient manner.

To be noted, even with a minimal gap portion Sp, it is possible to suppress the passage of the magnetic flux lines 82, but the larger the gap portion Sp, the greater the suppression of the passage of the magnetic flux lines 82. In this embodiment, the gap portions Sp are configured to extend outward beyond the virtual circle Cv, which is centered at the center CO of the magnetic core 23 and has the radius corresponding to the diameter of the magnetic core 23; however, it is not limited to this. For example, the gap portion Sp may be configured to extend outward beyond a virtual circle Cv, which is centered at the center CO of the magnetic core 23 and has the radius twice the diameter of the magnetic core 23. In this case, the suppression of the passage of the magnetic flux lines 82 can be further enhanced.

According to the above disclosures, the heat generation efficiency of the fixing film can be improved.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-223114, filed Dec. 18, 2024 which is hereby incorporated by reference herein in its entirety.

What is claimed is:

1. A fixing unit configured to fix a toner image on a recording material, the fixing unit comprising:
a rotary member that is configured to rotate and is formed in a tubular shape;
an opposing member configured to form a nip portion with the rotary member by coming into contact with an outer circumferential surface of the rotary member, the opposing member being configured to rotate around a rotational axis as a center, the rotational axis extending in an axial direction;
a magnetic core disposed in an internal space of the rotary member;
a conductive coil disposed in the internal space of the rotary member and including a helical portion helically wound around the magnetic core, the helical portion including a first end in the axial direction and a second end on a side opposite to the first end; and
a metallic side plate disposed at a position deviated in the axial direction with respect to a sheet passing area where the recording material passes by being nipped and conveyed in a conveyance direction by the rotary member and the opposing member,
wherein the side plate includes an inner surface facing the rotary member, and an outer surface that is an opposite surface of the inner surface, and
wherein, an overlap region includes a region of the magnetic core overlapped in the axial direction by a region of the helical portion between the first end and the second end, the overlap region includes a region that projects beyond the inner surface in a first direction that is a direction from the inner surface toward the outer surface.

2. The fixing unit according to claim 1,
wherein the overlap region includes a region that projects beyond the outer surface in the first direction.

3. The fixing unit according to claim 1,
wherein the side plate includes an opening portion through which the magnetic core and the conductive coil extend.

4. The fixing unit according to claim 3,
wherein the opening portion includes a gap portion disposed with a clearance with respect to the magnetic core and the conductive coil that extend through.

5. The fixing unit according to claim 4,
wherein, when viewed in the axial direction, part of the gap portion is positioned outside a virtual circle that is centered at a center of the magnetic core and has a radius equal to a diameter of the magnetic core.

6. The fixing unit according to claim 3,
wherein the side plate includes a U-shaped first member that, when viewed in the axial direction, opens in an intersecting direction intersecting with the axial direction and includes two terminal end portions facing a same direction in the intersecting direction, and a second member that connects the two terminal end portions of the first member, and
wherein the opening portion is formed by being at least partially enclosed by the first member and the second member.

7. The fixing unit according to claim 1,
wherein the side plate rotatably supports at least one of the rotary member and the opposing member.

8. The fixing unit according to claim 1,
wherein the overlap region includes a region that projects in the first direction beyond a terminal end of the rotary member in the first direction.

9. The fixing unit according to claim 1,
wherein the overlap region includes a region that projects in the first direction beyond a terminal end of the opposing member in the first direction.

10. The fixing unit according to claim 1,
wherein the side plate is made of non-magnetic metal.

11. The fixing unit according to claim 1,
further comprising a flange member supported by the side plate,
wherein the flange member rotatably supports the rotary member and holds the magnetic core and the conductive coil.

12. The fixing unit according to claim 11,
further comprising an urging member configured to urge the flange member toward the opposing member.

13. The fixing unit according to claim 1,
wherein the side plate is a first side plate, and the inner surface is a first inner surface,
wherein the fixing unit further comprises a metallic second side plate disposed at a position deviated in a second direction that is opposite to the first direction with respect to the sheet passing area,
wherein the first side plate and the second side plate rotatably support at least one of the rotary member and the opposing member,
wherein the second side plate includes a second inner surface that faces the rotary member, and
wherein the overlap region is a region that projects beyond the second inner surface in the second direction.

14. A fixing unit configured to fix a toner image on a recording material, the fixing unit comprising:
a rotary member configured to rotate and formed in a tubular shape;
an opposing member configured to form a nip portion with the rotary member by coming into contact with an outer circumferential surface of the rotary member and configured to rotate around a rotational axis as a center, the rotational axis extending in an axial direction;
a magnetic core disposed in an internal space of the rotary member;
a conductive coil disposed in the internal space of the rotary member and including a helical portion helically wound around the magnetic core, the helical portion including a first end in the axial direction and a second end on a side opposite to the first end; and
a metallic metal member disposed in the internal space of the rotary member,
wherein the metal member includes a downstream end in a first direction that is a direction from the first end toward the second end in the axial direction, and
wherein, in a case where a region where a region between the first end and the second end of the helical portion and a region where the magnetic core is present overlap in the axial direction is referred to as an overlap region, the overlap region includes a region that overlaps at least the downstream end.

15. The fixing unit according to claim 14,
wherein the overlap region includes a region that projects beyond the downstream end in the first direction.

16. The fixing unit according to claim 14,
wherein the downstream end is disposed at a position deviated in the first direction with respect to a sheet passing area where the recording material passes by being nipped and conveyed in a conveyance direction by the rotary member and the opposing member.

17. The fixing unit according to claim 14,
wherein the metal member is disposed to enclose the magnetic core along the axial direction, and has a shape that opens in a direction intersecting with the axial direction.

18. The fixing unit according to claim 14,
wherein the metal member supports the conductive coil and the magnetic core.

19. The fixing unit according to claim 14,
further comprising a sliding contact member disposed between the metal member and the rotary member, supported by the metal member, and configured to come into contact with an inner circumferential surface of the rotary member.

20. The fixing unit according to claim 19,
further comprising a support member disposed between the metal member and the sliding contact member, supported by the metal member, and supporting the sliding contact member.
